(19) United States
(12) Patent Application Publication
(10) Pub. No.: US 2026/0066142 A1
(43) Pub. Date: Mar. 5, 2026

(54) NUCLEAR POWER GENERATION SYSTEM AND CONTROL METHOD WITH SUPERCRITICAL CARBON DIOXIDE AS WORKING FLUID

(71) Applicant: Nuclear Power Institute of China, Chengdu (CN)

(72) Inventors: Yanping HUANG, Chengdu (CN); Xiuting LIU, Chengdu (CN); Wenbin ZHUO, Chengdu (CN); Houjun GONG, Chengdu (CN); Ruilong LIU, Chengdu (CN); Yaoxing CHEN, Chengdu (CN); Zhenjiang YU, Chengdu (CN); Jia TANG, Chengdu (CN); Xingjian PENG, Chengdu (CN); Shengjie QIN, Chengdu (CN)

(73) Assignee: Nuclear Power Institute of China, Chengdu (CN)

(21) Appl. No.: 19/379,633

(22) Filed: Nov. 4, 2025

Related U.S. Application Data
(63) Continuation of application No. PCT/CN2024/124445, filed on Oct. 12, 2024.

(30) Foreign Application Priority Data
Jun. 26, 2024 (CN) 202410837413.9

(51) Int. Cl. G21C 15/18; G21D 1/00

(52) U.S. Cl. CPC G21C 15/18; G21C 15/182; G21D 1/00

(57) ABSTRACT

The nuclear power generation system with supercritical carbon dioxide as working fluid includes a main power generation system, a waste heat discharging system, a working fluid filling control system, and a working fluid filling and recycling system, all of which use supercritical carbon dioxide as the working fluid. The main power generation system is configured to convert thermal energy into electrical energy, and includes a reactor and power generation system equipment.

### CROSS-REFERENCE TO RELATED APPLICATIONS

The present application is a continuation application of International Application No. PCT/CN2024/124445, filed on Oct. 12, 2024, which claims priority to Chinese Patent Application No. 202410837413.9, filed on Jun. 26, 2024. All of the aforementioned applications are incorporated herein by reference in their entireties.

### TECHNICAL FIELD

The present application relates to the technical field of nuclear power, and in particular, to a nuclear power generation system with supercritical carbon dioxide as working fluid, and a nuclear power generation control method.

### BACKGROUND

Nuclear power generation systems are an important tool of thermoelectric conversion in the power generation field due to their advantages such as high power density, stable energy output, long-term reliable operation, and environmental friendliness. The fourth-generation reactor includes liquid metal reactors such as lead-bismuth reactors and sodium-cooled fast reactors. Compared to traditional second- and third-generation nuclear reactors, these reactors are optimized in terms of nuclear safety, economics, reduction of nuclear waste, prevention of nuclear proliferation, elimination of severe accidents, and avoidance of off-site emergencies. Liquid metal reactors offer better thermal conductivity, higher safety, and more compact system layouts, making them suitable for miniaturization.

Traditional steam power generation systems have low thermoelectric conversion efficiency, high system complexity, more auxiliary systems, and large volume and weight, making the energy conversion method in urgent need of optimization. Furthermore, in traditional nuclear power generation systems, the coolant commonly used in the reactor's waste heat discharge system is typically water. The waste heat discharge system requires large-capacity cooling water tanks, and during the cooling process, the coolant undergoes phase changes within the reactor vessel. This can potentially impact the lifespan of the reactor pressure vessel, leading to a decrease in reactor safety. The waste heat removal during both reactor accident shutdowns and normal shutdowns needs to be designed with higher safety factors, greater efficiency, and lower failure probabilities, taking into account the characteristics of both the thermoelectric conversion system and the reactor. This design aims to avoid safety issues caused by phase changes, reduce damage to the reactor vessel, and ensure the integrity of the reactor vessel, thereby enhancing the safety during both normal and accident shutdowns.

The novel supercritical carbon dioxide power generation system is a compact, clean, efficient, and fast-response closed-loop power generation system. The system contains multiple feedback loops, and near the critical point, the physical properties change drastically, exhibiting strong non-linear characteristics. The system operation is sensitive to changes in physical properties, making the analysis and control of system behavior complex. The operating modes and control strategies of the system differ from those of traditional steam power generation systems, requiring the development of entirely new control and operational methods based on the characteristics of the working fluid, system configuration, and demand background.

### SUMMARY

To improve the safety of existing reactors and the efficiency of nuclear power generation systems, the present application provides a nuclear power generation system and control method with supercritical carbon dioxide as working fluid. The system and method feature high thermoelectric conversion efficiency, compactness, inherent safety, and simple and efficient operation control.

A liquid metal reactor is provided, offering higher thermal conductivity and inherent safety. An intermediate heat exchanger is arranged within the reactor, further enhancing compactness and enabling miniaturization. The main power generation system is configured to convert thermal energy into electrical energy, characterized by high thermoelectric conversion efficiency, small size, and fast load-following capabilities. An active waste heat discharging system and a passive waste heat discharging system are also provided, which enable the extraction of core heat under reactor accident conditions or even during complete station blackout, ensuring reactor safety. A working fluid filling control system is provided to enable efficient load regulation of the power generation system. A working fluid filling and recycling system is configured to support mobility of the system, capable of providing working fluid filling at any time, and recycling and reusing the “exhaust gas mixture” generated by the system to improve energy utilization and thermoelectric conversion efficiency while reducing waste emissions. A local efficient load-following control method is proposed, including working fluid filling control, bypass regulation, and throttling control, which enable matching of the optimal load regulation strategy for different load regions.

The technical solution adopted by the embodiments of the present application to solve the above technical problem is as follows.

A nuclear power generation system with supercritical carbon dioxide as a working fluid is provided, wherein the nuclear power generation system comprises a main power generation system, a waste heat discharging system, a working fluid filling control system, and a working fluid filling and recycling system, and the main power generation system, the waste heat discharging system, the working fluid filling control system and the working fluid filling and recycling system each have the supercritical carbon dioxide as the working fluid.

The main power generation system is configured to convert thermal energy into electrical energy, and comprises a reactor and power generation system equipment, the power generation system equipment comprises a turbine, a generator, a high-temperature recuperator, a low-temperature recuperator, a first cooler, a first pressurizing branch, and a second pressurizing branch, a first-stage compressor, a second cooler, and a second-stage compressor are sequentially arranged on the first pressurizing branch, a second compressor is arranged on the second pressurizing branch, the working fluid output from the reactor is configured to enter the turbine to perform work, the turbine is configured to drive the generator to generate electricity, and the spent working fluid after expansion is configured to sequentially enter the high-temperature recuperator and the low-temperature recuperator for heat release, the working fluid after heat release is configured to enter the first cooler for cooling, and the cooled working fluid is configured to enter the first-stage compressor for compression, the compressed working fluid is cooled in the second cooler, and the cooled working fluid is further compressed in the second-stage compressor, the high-pressure working fluid compressed by the first-stage compressor and the second-stage compressor is configured to sequentially enter the high-temperature recuperator and the low-temperature recuperator to absorb heat, the working fluid at the outlet of the low-temperature recuperator is further configured to enter the second compressor for compression, the high-pressure working fluid compressed by the second compressor is merged with the working fluid at the outlet of the low-temperature recuperator and re-enters the high-temperature recuperator to absorb heat, the heat-absorbed working fluid is further configured to enter the reactor to absorb heat and become a high-temperature and high-pressure working fluid.

A reactor working fluid outlet is connected to an inlet of the turbine via a turbine inlet pipeline, an outlet of the turbine is connected to a heat release inlet of the high-temperature recuperator via an exhaust gas delivery pipeline, a reactor working fluid inlet is connected to a heat absorption outlet of the high-temperature recuperator via a working fluid input pipeline, and a compression outlet of the second stage of the first compressor is connected to a heat absorption inlet of the low-temperature recuperator through a high-pressure working fluid delivery pipeline.

The turbine inlet pipeline is connected to the exhaust gas delivery pipeline through a turbine bypass pipeline, and the turbine bypass pipeline is configured to implement load regulation and load shedding; the working fluid input pipeline is connected to the turbine inlet pipeline through a reactor bypass pipeline, and the reactor bypass pipeline is configured to isolate the reactor from the main power generation system; the high-pressure working fluid conveying pipeline is in communication with an inlet of the first cooler through a first compressor bypass pipeline, and the first compressor bypass pipeline is configured to implement working fluid flow regulation and load regulation.

The power generation system further comprises a first speed increaser, a first motor, a second speed increaser, a second motor, and a speed reducer; the first-stage compressor, the second-stage compressor, and the first motor are coaxially arranged; the first-stage compressor, the second-stage compressor, and the first motor are connected via gears within the first speed increaser; the second compressor and the second motor are coaxially arranged; the second compressor and the second motor are connected via gears within the second speed increaser; the turbine and the generator are coaxially arranged, and the turbine and the generator are connected via gears within the speed reducer.

The first cooler, the second cooler, the high-temperature recuperator, and the low-temperature recuperator are all configured as printed circuit heat exchanger (PCHE)-type microchannel high-efficiency heat exchangers, which enable compact volume and high specific surface area heat exchange.

The speed reducer, the first speed increaser, and the second speed increaser are each connected to a recovered working fluid inlet pipeline of the working fluid filling and recycling system through a first pipeline; and the inlet of the first cooler is in communication with a main power generation system working fluid filling outlet pipeline of the working fluid filling and recycling system via a second pipeline, wherein the working fluid filling and recycling system is configured to recycle the working fluid.

An inlet of the first cooler is in communication with a working fluid filling control system outlet pipeline of the working fluid filling control system through a third pipeline, and an outlet of the second compressor is in communication with a working fluid filling control system inlet pipeline of the working fluid filling control system through a fourth pipeline, wherein the working fluid amount control system is configured to vary a load of the main power generation system.

The reactor comprises a control rod drive mechanism, a reactor vessel, a reactor core, a coolant, a coolant pump, and an intermediate heat exchanger, wherein the control rod drive mechanism is configured to move the reactor core up and down; the reactor core, the coolant, the coolant pump, and the intermediate heat exchanger are all disposed within the reactor vessel; the reactor core is configured to release heat to the coolant; the coolant pump is configured to circulate the coolant; the coolant is configured to release heat to the intermediate heat exchanger; the working fluid in the main power generation system is configured to enter the intermediate heat exchanger to absorb heat; an inlet of the intermediate heat exchanger is in communication with the reactor working fluid inlet; and an outlet of the intermediate heat exchanger is in communication with the reactor working fluid outlet.

The intermediate heat exchanger is a printed circuit heat exchanger (PCHE), a plurality of intermediate heat exchangers are arranged circumferentially along the reactor vessel, and each intermediate heat exchanger has a high-temperature side and a low-temperature side; the coolant is a liquid metal coolant and flows through the high-temperature side, and the working fluid of the main power generation system flows through the low-temperature side; and the inlet of the intermediate heat exchanger is in communication with the reactor working fluid inlet, and the outlet of the intermediate heat exchanger is in communication with the reactor working fluid outlet.

The reactor further comprises a thermally conductive internal partition, and the reactor vessel is divided by the thermally conductive internal partition into a working chamber and an auxiliary chamber that are independent of each other; the reactor core, the coolant, the coolant pump, and the intermediate heat exchanger are all located within the working chamber of the reactor vessel; an upper portion of the auxiliary chamber is annular in shape, and a lower portion of the working chamber is inserted within the upper portion of the auxiliary chamber; a waste heat outlet and a waste heat inlet are provided on the reactor vessel, and both the waste heat outlet and the waste heat inlet are in communication with the auxiliary chamber.

The waste heat discharging system comprises an active waste heat discharging system pipeline, and the supercritical carbon dioxide serves as a circulating cooling working fluid within the active waste heat discharging system pipeline; along a direction from an inlet to an outlet of the active waste heat discharging system pipeline, a fourth cooler, a first booster pump, and a first heater are sequentially arranged on the active waste heat discharging system pipeline; the inlet of the active waste heat discharging system pipeline is in communication with the reactor working fluid outlet, and the outlet of the active waste heat discharging system pipeline is in communication with the reactor working fluid inlet.

When the reactor is shut down under normal conditions and the active waste heat discharging system pipeline is activated to perform cooling, a first valve on the working fluid input pipeline is closed, and a second valve on a reactor bypass pipeline is opened, so that the high-pressure working fluid having absorbed heat from the high-temperature recuperator does not enter the reactor but instead enters the turbine through the reactor bypass pipeline, and the working fluid discharged from the reactor working fluid outlet is returned to the reactor working fluid inlet through the fourth cooler and the first booster pump in the active waste heat discharging system pipeline, thereby cooling the reactor core. When the reactor is shut down for maintenance and heating is required to maintain the temperature of the coolant, the working fluid discharged from the reactor working fluid outlet is returned to the reactor working fluid inlet through the first booster pump and the first heater in the active waste heat discharging system pipeline, thereby providing heat tracing for the coolant of the reactor core.

The waste heat discharging system comprises a passive waste heat discharging system pipeline, the passive waste heat discharging system pipeline employs the supercritical carbon dioxide as a circulating cooling working fluid, and a third cooler is disposed on the passive waste heat discharging system pipeline; the third cooler is located inside a water tank, and the third cooler is provided with a cold source by the water tank; an inlet of the passive waste heat discharging system pipeline is in communication with both the reactor working fluid outlet and the waste heat outlet, and an outlet of the passive waste heat discharging system pipeline is in communication with both the reactor working fluid inlet and the waste heat inlet.

When an emergency shutdown of the reactor occurs and the passive waste heat discharging system pipeline is activated to perform cooling, the circulating cooling working fluid in the passive waste heat discharging system pipeline enters the reactor from the reactor working fluid outlet and the waste heat outlet, and the circulating cooling working fluid within the reactor enters the passive waste heat discharging system pipeline from the reactor working fluid inlet and the waste heat inlet.

The working fluid filling and recycling system comprises the recovered working fluid inlet pipeline, a filling heat exchanger, a working fluid storage tank, and a second heater, wherein an outlet of the recovered working fluid inlet pipeline is connected to a heat release inlet of the filling heat exchanger; a heat release outlet of the filling heat exchanger is connected to an inlet of the working fluid storage tank through a heat release branch pipeline; a heat absorption inlet of the filling heat exchanger is connected to an outlet of the working fluid storage tank through a heat absorption inlet branch pipeline; a heat absorption outlet of the filling heat exchanger is connected to an inlet of the second heater through a heat absorption outlet branch pipeline; an outlet of the second heater is in communication with an inlet of the first cooler through a main power generation system working fluid filling outlet pipeline; the outlet of the second heater is further connected in sequence to the active waste heat discharging system pipeline through an active waste heat discharging system filling outlet pipeline and a fifth pipeline; the outlet of the second heater is also connected in sequence to the passive waste heat discharging system pipeline through a passive waste heat discharging system filling outlet pipeline and a sixth pipeline.

The recovered working fluid inlet pipeline is sequentially provided with an induced draft fan, an oil-gas separation and cooling device, a high-temperature heating furnace, a dust filter, and a dryer in a direction from an inlet to the outlet of the recovered working fluid inlet pipeline; an inlet of the high-temperature heating furnace is in communication with an exhaust port of the oil-gas separation and cooling device; an oil discharge port of the oil-gas separation and cooling device is sequentially connected to an oil filter, a sixth cooler, and a lubricating oil tank; a fifth cooler is disposed on the heat release branch pipeline; and a second booster pump is disposed on the heat absorption inlet branch pipeline.

The working fluid filling control system comprises a working fluid tank, an outlet of the working fluid tank is connected to a working fluid filling control system outlet pipeline, and an inlet of the working fluid tank is connected to the working fluid filling control system inlet pipeline; the working fluid tank is connected to a cooling water pipe array and an electric heating rod, the cooling water pipe array being configured to cool the working fluid inside the working fluid tank, and the electric heating rod being configured to heat the working fluid inside the working fluid tank.

A nuclear power generation control method, wherein the nuclear power generation control method is applied to the nuclear power generation system as described above, and the nuclear power generation control method comprises: when a change in the power grid or load occurs, responding to the change in the power grid or load by regulating electrical output of a generator, and determining a rated load, a current load, a load variation amplitude, and a target load of the main power generation system, wherein the load variation amplitude is a difference between the target load and the current load; when it is sequentially determined that the current load is less than 50% of the rated load and the load variation amplitude is less than 20% of the rated load, performing a variable load response through working fluid filling control; when it is sequentially determined that the current load is less than 50% of the rated load and the load variation amplitude is greater than or equal to 20% of the rated load, performing a variable load response through bypass regulation; when it is sequentially determined that the current load is greater than or equal to 50% of the rated load and the load variation amplitude is less than 20% of the rated load, performing a variable load response through the working fluid filling control; and when it is sequentially determined that the current load is greater than or equal to 50% of the rated load and the load variation amplitude is greater than or equal to 20% of the rated load, performing a variable load response through throttling control.

The working fluid filling control comprises: determining a required valve opening under the load variation amplitude based on the current load and a valve opening-load curve; performing coarse adjustment on valves located on a working fluid filling control system outlet pipe and a working fluid filling control system inlet pipe; and performing fine adjustment on the valves located on the working fluid filling control system outlet pipe and the working fluid filling control system inlet pipeline through feedback control based on a load deviation between the current load and a required load, to accurately control a loaded amount of working fluid in a working fluid tank and in the main power generation system, thereby ultimately changing an output load of the generator.

The working fluid filling control comprises: adjusting a cooling water pipe array and an electric heating rod through feedback control based on a deviation between a set value and a measured value of a thermophysical property of the working fluid in the working fluid tank, to compensate for a thermophysical property disturbance of the working fluid in the working fluid tank caused by a change in valve opening on the working fluid filling control system outlet pipe and a working fluid filling control system inlet pipe.

The bypass regulation comprises: determining, based on a current load and a valve opening-load curve, required valve openings on a turbine bypass pipe and a compressor bypass pipe under the load variation amplitude; performing coarse adjustment on valves on the turbine bypass pipe and the compressor bypass pipe; and performing fine adjustment on the valve on the turbine bypass pipe through feedback control based on a load deviation between the current load and a required load, to ultimately change an output load of the generator by varying a working fluid flow rate in the main power generation system.

The throttling control comprises: determining, based on a current load and a valve opening-load curve, a required valve opening on a turbine inlet pipeline under the load variation amplitude; performing coarse adjustment on a valve on the turbine inlet pipe; and performing fine adjustment on the valve on the turbine inlet pipeline through feedback control based on a load deviation between the current load and a required load, to ultimately change an output load of the generator by varying an intake volume of the turbine.

The beneficial effects of the embodiments of the present application are as follows. The thermoelectric conversion efficiency of nuclear power generation systems can be improved, system compactness and safety can be enhanced, and the technical solution of the present application can be widely applied in nuclear power generation systems. The nuclear power generation system with supercritical carbon dioxide as working fluid replaces traditional water-based power systems and water-based heat discharge systems, achieving efficient heat exchange, safe shutdown, and emergency shutdown response. Additionally, the working fluid recycling and purification can improve energy utilization and reduce waste emissions, making such system environmentally friendly. This aligns with the development direction of clean energy in the future.

### BRIEF DESCRIPTION OF THE DRAWINGS

The accompanying drawings constituting a part of the present application are used to provide a further understanding of the present application, and the illustrative embodiments of the present application and the description thereof are used to explain the present application, and do not constitute an improper limitation on the present application.

FIG. 1 is a schematic diagram showing a nuclear power generation system with supercritical carbon dioxide as working fluid according to the present application.

FIG. 2 is a schematic diagram showing a working fluid filling and recycling system.

FIG. 3 is a schematic diagram showing a working fluid filling control system.

FIG. 4 is a schematic diagram showing a reactor.

FIG. 5 is a schematic flowchart showing a nuclear power generation control method.

FIG. 6 is a schematic flowchart showing load control in working fluid filling control.

FIG. 7 is a schematic flowchart showing working fluid tank control in the working fluid filling control.

FIG. 8 is a schematic flowchart showing bypass regulation.

FIG. 9 is a schematic flowchart showing throttling control.

### DETAILED DESCRIPTION OF THE EMBODIMENTS

It should be noted that, in the case of no conflict, the embodiments in the present application and the features in the embodiments may be combined with each other. The present application will be described in detail below with reference to the accompanying drawings and in combination with the embodiments.

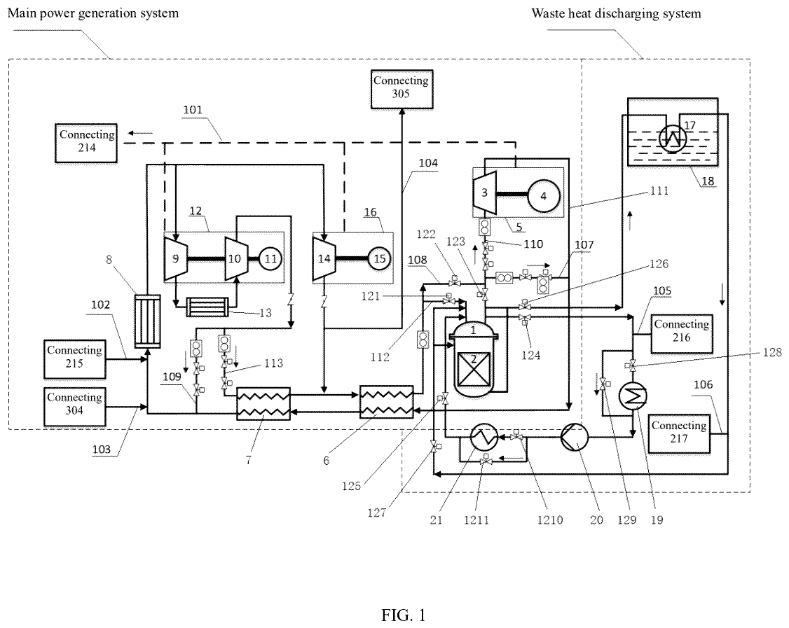

As shown in FIG. 1 to FIG. 4, the nuclear power generation system with supercritical carbon dioxide as working fluid according to the embodiments of the present application comprises a main power generation system, a waste heat discharging system, a working fluid filling control system, and a working fluid filling and recycling system. The main power generation system, the waste heat discharging system, the working fluid filling control system and the working fluid filling and recycling system each have the supercritical carbon dioxide as the working fluid.

The nuclear power generation system can convert heat energy in the reactor 1 into electric energy, and a supercritical carbon dioxide Brayton cycle power generation system with high thermoelectric conversion efficiency is provided. A compact and integrated arrangement is provided in which the intermediate heat exchanger 2 is built into the reactor 1. An active waste heat discharging system and a passive waste heat discharging system are also provided, enabling the extraction of core thermal energy even in the event of accident of the reactor 1 or a complete power outage, thereby ensuring the safety of the nuclear reactor. A working fluid filling control system is configured to enable efficient load variation in the power generation system. A working fluid filling and recycling system is also provided to facilitate mobility of the system described herein, offering the capability to supply working fluid at any time and to recycle and reuse the exhaust mixture generated by the system, thereby improving energy utilization and thermoelectric conversion efficiency while reducing waste emissions. The nuclear power generation system thus features high efficiency, compactness, and inherent safety.

The primary power generation system converts thermal energy to electrical energy, including the reactor 1 and a power generation system device. The reactor 1 in the main power generation system adopts a liquid metal reactor, for example, a liquid metal reactor such as a lead-bismuth reactor or a sodium-cooled fast reactor, which is a fourth generation novel reactor. The coolant in the reactor core is a liquid metal coolant, including but not limited to lead-bismuth alloy coolant and sodium coolant, offering the advantage of higher inherent safety.

The reactor in the main power generation system comprises a reactor core 403, a reactor vessel 402, a control rod drive mechanism 401, a coolant pump 405, an intermediate heat exchanger 2, a working chamber, and an auxiliary chamber 404. The intermediate heat exchanger 2 adopts a PCHE type efficient and compact heat exchanger, is built in the reactor vessel 402, has higher compactness and higher inherent safety. Multiple intermediate heat exchangers 2 may be arranged based on the spatial configuration of in-core equipment, and are annularly distributed around the reactor core 403. Each intermediate heat exchanger 2 includes a high-temperature side and a low-temperature side. The liquid metal coolant from the reactor core flows through the high-temperature side, while the carbon dioxide working fluid flows through the low-temperature side. The entire intermediate heat exchanger is immersed in the coolant in the reactor core, and the coolant pump 405 provides power for circulating the coolant.

As shown in FIG. 4, the working fluid circulation process in the reactor 1 is as follows. The working fluid from the main power generation system enters the cold side of the intermediate heat exchanger 2 via the reactor working fluid inlet 406, exchanges heat with the reactor coolant on the hot side, and exits from the reactor working fluid outlet 407. The hot side working fluid of the intermediate heat exchanger 2 is the reactor coolant, which may optionally be a liquid metal. The coolant pump 405 provides circulation power for the reactor coolant, forming flow and heat exchange conditions within the reactor vessel to exchange heat with the reactor core 403. This cools the reactor core 403 and transfers heat to the working fluid of the main power generation system. The control rod drive mechanism 401 regulates the power output of the reactor core, and the auxiliary chamber 404 provides an interface for waste heat removal.

The working fluid of the power generation system in the main power generation system is supercritical carbon dioxide. The power generation cycle configuration is an intercooling recompression Brayton cycle, or may also adopt other cycle configurations, including but not limited to a supercritical carbon dioxide simple recuperated Brayton cycle, a supercritical carbon dioxide recompression Brayton cycle, and a supercritical carbon dioxide reheated Brayton cycle.

The working process of the power generation system in the main power generation system is as follows. The high-temperature and high-pressure supercritical carbon dioxide working fluid coming out of the intermediate heat exchanger 2 in the reactor 1 enters the turbine 3 to perform work and drive the generator 4 to generate electricity, thereby converting thermal energy into electrical energy. The expanded exhaust gas enters the hot side of the high-temperature recuperator 6 to preheat the working fluid on the cold side, and then enters the low-temperature recuperator 7 to further release heat. The working fluid discharged from the outlet of the low-temperature recuperator 7 is divided into two branches. The first branch enters the first cooler 8 for further cooling. The cooled exhaust gas then sequentially enters the first-stage 9 and second-stage 10 of the first compressor to be compressed. A second cooler 13 is provided between the first-stage compressor 9 and the second-stage compressor 10 to cool the carbon dioxide working fluid that has been heated by compression in the first-stage compressor 9, thereby reducing the compression work of the subsequent second-stage compressor 10 and improving the thermoelectric conversion efficiency of the system. The presence of the second cooler 13 cools the compressed and heated working fluid, reduces the power consumption of the second-stage compressor, and ultimately achieves the goal of improving the efficiency of the thermoelectric conversion system. The working fluid discharged from the second cooler 13 enters the second-stage compressor 10 of the first compressor for further pressurization, and then enters the cold side of the low-temperature recuperator 7 for preheating. The first motor 11 provides power for both the first-stage 9 and second-stage 10 of the first compressor. The second branch directly enters the second compressor 14 for pressurization, with the second motor 15 providing power. The working fluid pressurized by the second compressor 14 mixes with the working fluid at the outlet of the low-temperature recuperator 7, and the mixture enters the cold side of the high-temperature recuperator 6 for further preheating. The preheated working fluid then enters the intermediate heat exchanger 2 to absorb heat. After absorbing heat, the high-temperature and high-pressure carbon dioxide working fluid enters the turbine 3 to perform work, thereby completing a closed-loop cycle.

The reactor working fluid outlet 407 is connected to the inlet of the turbine 3 through the turbine inlet pipeline 110. The outlet of the turbine 3 is connected to the heat release inlet of the high-temperature recuperator 6 via the exhaust gas delivery pipeline 111. The reactor working fluid inlet 406 is connected to the heat absorption outlet of the high-temperature recuperator 6 via the working fluid inlet pipeline 112. The heat absorption outlet of the high-temperature recuperator 6 is in communication with the heat absorption outlet of the low-temperature recuperator 7. The outlet of the second stage of the first compressor 10 is connected to the heat absorption inlet of the low-temperature recuperator 7 via the high-pressure working fluid delivery pipeline 113. The turbine inlet pipeline 110 is connected to the exhaust gas delivery pipeline 111 via the turbine bypass pipe 107. The working fluid inlet pipeline 112 is connected to the turbine inlet pipeline 110 via the reactor bypass pipe 108. The high-pressure working fluid delivery pipeline 113 is in communication with the inlet end of the first cooler 8 via the main compressor bypass pipe 109.

The reactor 1 further includes a thermally conductive internal partition 408. The reactor vessel 402 is internally divided by the thermally conductive internal partition 408 into mutually independent working and auxiliary chambers 404. The working chamber and the auxiliary chamber 404 are arranged vertically, with the core 403, the coolant, the coolant pump 405, and the intermediate heat exchanger 2 all located within the working chamber of the reactor vessel 402. The upper portion of the auxiliary chamber 404 is annular, and the lower portion of the working chamber is inserted within the upper portion of the auxiliary chamber 404. A waste heat outlet 410 and a waste heat inlet 409 are provided on the reactor vessel 402, and both the waste heat outlet 410 and the waste heat inlet 409 are in communication with the auxiliary chamber 404.

The power generation system in the main power generation system is equipped with a turbine bypass pipeline 107, a reactor bypass pipeline 108, and a main compressor bypass pipeline 109 to achieve power adjustment and control of the system.

The main compressor unit in the power generation system includes a first-stage compressor 9, a second-stage compressor 10, a first speed increaser 12, and a first motor 11. The first-stage compressor 9, second-stage compressor 10, and first motor 11 are coaxially arranged and connected through gears in the first speed increaser 12, with lubricating oil bearings set in the gearbox. The auxiliary compressor includes a second compressor 14, a second speed increaser 16, and a second motor 15. The second compressor 14 and second motor 15 are coaxially arranged and connected through gears in the second speed increaser 16, with lubricating oil bearings set in the gearbox.

The turbine generator set includes a turbine 3, a speed reducer 5, and a generator 4. The turbine 3 and the generator 4 are coaxially arranged and connected through gears in the speed reducer 5, with lubricating oil bearings set in the speed reducer. The carbon dioxide working fluid and oil mist mixture generated in the above gearboxes are recovered and purified through the working fluid filling purification system, with the interface being the first pipeline 101 and the recovered working fluid inlet pipeline 214.

The power generation system in the main power generation system is equipped with a third pipeline 103 and a fourth pipeline 104. The third pipeline 103 connects to the working fluid filling control system outlet pipeline 304, and the fourth pipeline 104 connects to the working fluid filling control system inlet pipeline 305, enabling the adjustment of working fluid quantity in the power generation system and realizing efficient load regulation of the system.

The power generation system in the main power generation system is equipped with a first pipeline 101 and a second pipeline 102. The first pipeline 101 connects to the recovered working fluid inlet pipeline 214, and the second pipeline 102 connects to the main power generation system working fluid filling outlet pipeline 215, enabling the working fluid filling, recycling, and lubricating oil recycling in the power generation system

The waste heat discharging system described in the present application includes an active waste heat discharging system and a passive waste heat discharging system.

The waste heat discharging system uses supercritical carbon dioxide as the working fluid. Currently, there are no known patent applications related to the use of supercritical carbon dioxide as the working fluid in a reactor's waste heat discharging system. Since supercritical carbon dioxide does not undergo phase change, it avoids the thermal stress issues and material fatigue life problems caused by phase changes in water-based working fluids, which significantly enhances the safety of the reactor, ensures the integrity of the reactor, and reduces the probability of severe accidents. Carbon dioxide is also the working fluid in the power generation system of the main power generation system, with stable gas sources. The use of liquid storage tanks for storage allows for mobility and transportation, with strong environmental adaptability and flexible arrangement. The active waste heat discharging system includes the fourth cooler 19 to discharge heat, the first booster pump 20 to provide power for the working fluid circulation, and the first heater 21 to provide heat when the reactor requires heat tracing.

The operational process of the active waste heat discharging system is as follows. When the reactor is in a normal shutdown state and requires the activation of the active waste heat discharging system for cooling, the first valve 121, the third valve 123, the ninth valve 129, and the tenth valve 1210 are closed, while the fourth valve 124, the fifth valve 125, the eighth valve 128, the eleventh valve 1211, and the second valve 122 are opened. The power generation system in the main power generation system enters the turbine directly through the reactor bypass pipeline 108, bypassing the intermediate heat exchanger 2 in the reactor core. In the active waste heat discharging system, the carbon dioxide is pressurized by the first booster pump 20 and flows through the eleventh valve 1211 into the intermediate heat exchanger 2 in the reactor 1, where it exchanges heat with the reactor core coolant. After removing the core's waste heat, the flow passes through the fourth valve 124 and the eighth valve 128 to enter the fourth cooler 19 for cooling. After cooling, the flow is sent back through the first booster pump 20 to the core, completing a closed loop and discharging the core's waste heat. When the reactor is shut down for maintenance and requires heating to maintain the coolant temperature in the core, the first valve 121, the third valve 123, the eighth valve 128, and the eleventh valve 1211 are closed, while the fourth valve 124, the fifth valve 125, the ninth valve 129, and the eleventh valve 1211 are opened, isolating the power generation system. In this case, the power generation system in the main power generation system enters the turbine 3 directly through the reactor bypass pipeline 108, bypassing the intermediate heat exchanger 2 in the core. In the active waste heat discharging system, the carbon dioxide is pressurized by the first booster pump 20 and enters the first heater 21 for heating. The heated working fluid then enters the intermediate heat exchanger 2 to exchange heat with the core coolant, raising the coolant to the specified temperature. The flow is then returned through the fourth valve 124 and the ninth valve 129 to the first booster pump 20, completing a closed loop and providing heat tracing for the core.

The passive waste heat discharging system includes a third cooler 17 for cooling, a water tank 18 providing a cold source, and corresponding pipeline valve connections. The passive waste heat discharging system uses supercritical carbon dioxide as the circulating working fluid. This working fluid has the characteristic of exhibiting a high-density difference with changes in pressure and temperature. By utilizing the physical properties of this working fluid, which provides strong natural circulation capabilities, it is possible to passively discharge the core's waste heat. Even in the event of a reactor accident or a total power outage in the plant, the passive waste heat discharging system can still ensure the discharge of core waste heat, guaranteeing the reactor's safety and preventing the occurrence of severe reactor accidents.

The working process of the passive waste heat discharging system is as follows. When a reactor accident causes a shutdown and the passive waste heat discharging system is required for cooling, the first valve 121 and the third valve 123 are closed, and the second valve 122, the sixth valve 126, and the seventh valve 127 are opened. The circulating carbon dioxide working fluid is split into two branches, with one branch entering the reactor inlet pipeline and flowing into the reactor core. The other branch enters the auxiliary chamber 404, achieving uniform cooling of the reactor vessel's annular region. Afterward, the two branches of carbon dioxide working fluid meet and flow out through the reactor outlet pipeline. The carbon dioxide working fluid heated by the reactor core increases in temperature and pressure, causing its density to decrease. Natural circulation buoyancy is generated in the pipeline, and the fluid rises through the sixth valve 126 to the high-level water tank 18. In the water tank, the third cooler 17 facilitates heat exchange with water, cooling the fluid. The cooled carbon dioxide's temperature and pressure drop, and its density increases. Under the influence of gravity, the fluid flows through the seventh valve 127 back into the reactor 1, where it continues to be heated, forming a closed passive waste heat cooling circulation loop.

The working fluid from the passive waste heat discharging system enters the reactor core 403 to absorb heat through two branches, ensuring synchronized cooling of the reactor components and reactor shell. This ensures uniform cooling, avoiding thermal stress issues and material fatigue problems, significantly improving reactor safety, maintaining the integrity of the reactor, and reducing the likelihood of severe accidents.

The working fluid filling and recycling system described in the present application provides carbon dioxide working fluid to the main power generation system, the active waste heat discharging system, and the passive waste heat discharging system. Additionally, this system recycles carbon dioxide working fluid that leaks into the speed increasers/reducers. This system prevents the need for supplemental working fluid during long-term power generation operations. Since the carbon dioxide working fluid leaked into the speed increasers/reducers mixes with lubricating oil vapor to form an oil-gas mixture, this mixture must be separated. The system then recovers both carbon dioxide working fluid and lubricating oil. This process improves energy utilization, reduces the emission of waste during system operation, and reduces the need for supplemental power generation working fluid.

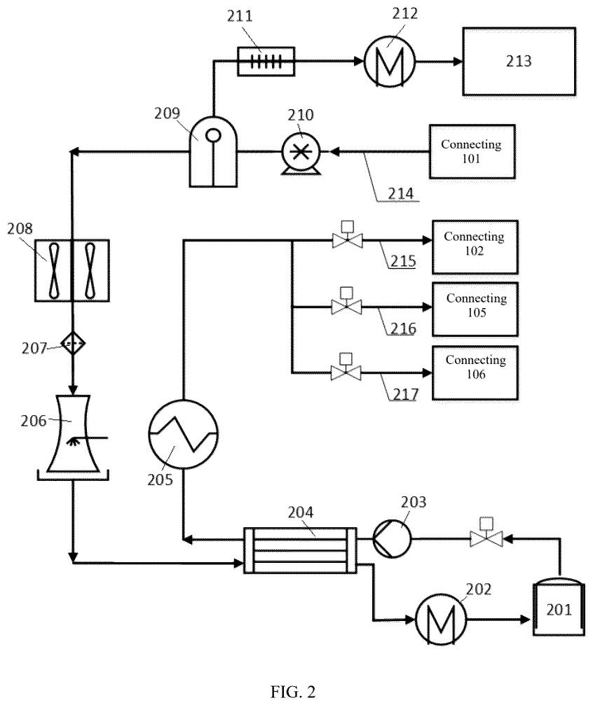

As shown in FIG. 2, the working fluid filling and recycling system described in the present application includes a working fluid storage tank 201 capable of storing low-temperature and low-pressure liquid working fluid, such as liquid carbon dioxide, providing a gas source for fluid charging. The liquid state storage of the working fluid is compact, and its storage space is small and transportable. The system also includes a second booster pump 203 for pressurizing the working fluid and providing power for the fluid circulation. Additionally, a filling heat exchanger 204 is provided to reduce the capacity of the fifth cooler 202 and the second heater 205, thereby reducing costs and improving economic efficiency. The filling heat exchanger 204 utilizes the waste heat from the recovered working fluid to preheat the working fluid exiting the storage tank 201. A second heater 205 is included to heat the carbon dioxide working fluid to the specified temperature before it is injected into the power generation system. The system further includes a dryer 206, a dust filter 207, and a high-temperature heating furnace 208. These components are used to carbonize the small amount of remaining oil mist after oil mist separation by using high-temperature oil mist carbonization, ensuring the purity of the recovered working fluid. An oil-gas separation and cooling device 209 is used to separate oil mist and carbon dioxide working fluid, while an oil filter 211, a sixth cooler 212, and a lubricating oil tank 213 complete the recycling, filtration, and storage of lubricating oil after the separation of oil mist and working fluid.

The working fluid filling and recycling system described in the present application operates as follows.

The working fluid filling process is as follows. Liquid carbon dioxide working fluid from the working fluid storage tank 201 is pressurized by the second booster pump 203 and enters the filling heat exchanger 204 for preheating. After absorbing heat, the fluid flows into the second heater 205 for further heating. Once heated to the specified temperature, the working fluid is delivered via the main power generation system working fluid filling outlet pipeline 215, the active waste heat discharging system filling outlet pipeline 216, or the passive waste heat discharging system filling outlet pipeline 217, to the respective system for charging. For example, the outlet of the second heater 205 is sequentially connected through the active waste heat discharging system filling outlet pipeline 216 and the fifth pipeline 105 to the pipeline of the active waste heat discharging system. Similarly, the outlet of the second heater 205 is also connected through the passive waste heat discharging system filling outlet pipeline 217 and the sixth pipeline 106 to the pipeline of the passive waste heat discharging system.

The working fluid recycling process is as follows. The oil vapor working fluid mixture discharged from the speed increaser/reducer enters the recovered working fluid inlet pipeline 214 via the first pipeline 101. It is then drawn in by the induced draft fan 210 and directed into the oil-gas separation and cooling device 209, where a coarse separation of carbon dioxide working fluid and oil mist takes place. The separated oil mist is routed through the oil filter 211 and the sixth cooler 212 for purification and recycling of lubricating oil, which is ultimately stored in the lubricating oil tank 213. The carbon dioxide working fluid, which still contains trace oil mist after coarse separation, is further heated in the high-temperature heating furnace 208, where residual oil mist is carbonized. This ensures high purity of the recovered working fluid, i.e., carbonized particles adhere to the inner walls of the furnace. The purified carbon dioxide working fluid then passes sequentially through the dust filter 207 and dryer 206 for further purification. After that, it enters the filling heat exchanger 204, where it preheats the outgoing liquid working fluid from the storage tank. Finally, the recovered fluid is cooled in the fifth cooler 202 to be liquefies and returned to the working fluid storage tank 201.

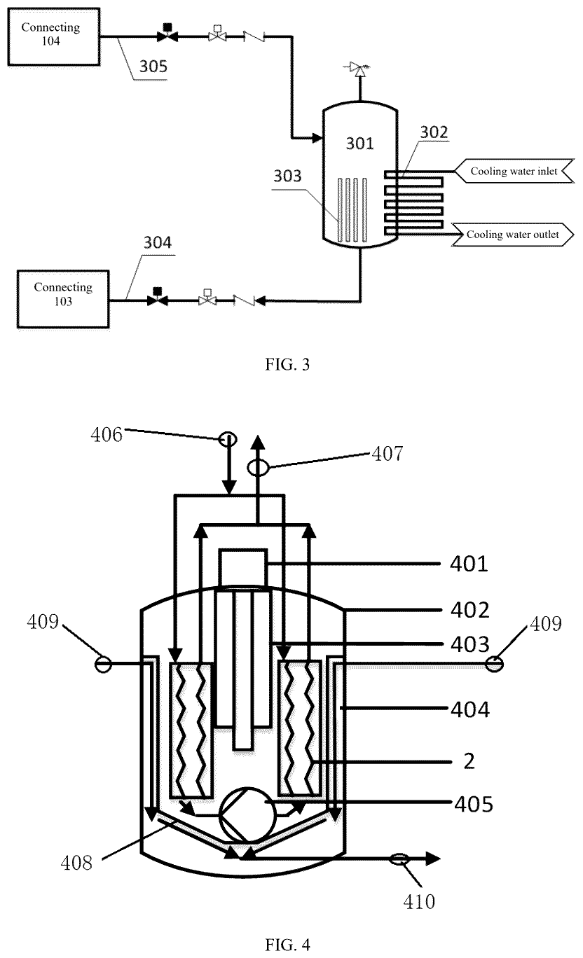

As shown in FIG. 3, the working fluid filling control system of the present application is capable of achieving the requirement for efficient and rapid load variation of the power generation system. By utilizing the characteristic of carbon dioxide working fluid, wherein the density varies greatly with pressure and temperature changes, the system changes the inventory of the working fluid in the power generation loop, thereby changing the output power of the turbine-generator set. The system includes a working fluid tank 301 for storing the system working fluid, a cooling water pipe array 302 for cooling the working fluid to change the pressure and density of the fluid inside the tank, and an electric heating rod 303 for heating the working fluid to change the pressure and density of the fluid inside the tank. The inlet and outlet pipelines of the working fluid filling control system are used to realize working fluid displacement.

The working fluid filling control system of the present application operates as follows: the working fluid filling control system inlet pipeline 305 is connected to the fourth pipeline 104, and the outlet pipeline 304 is connected to the third pipeline 103. When the system needs to reduce load, the valve on the working fluid filling control system inlet pipeline 305 is opened, and the valve on the outlet pipeline 304 is closed. The high-pressure working fluid at the outlet of the second compressor 14 enters the working fluid tank 301 under the effect of pressure differential, reducing the amount of working fluid performing work in the power generation system, thereby decreasing the working capacity and reducing the electrical output power in response to the load reduction operation. When the system needs to increase load, the carbon dioxide working fluid in the working fluid tank 301 is returned to the power generation system through the outlet pipeline 304 of the working fluid filling control system based on the density difference, i.e., pressure difference. The working fluid at the third pipeline 103 is in the low-pressure section of the system. By controlling the cooling function of the cooling water pipe array 302 and the heating function of the electric heating rod 303, the pressure in the working fluid tank 301 is adjusted such that the density of the working fluid inside the tank is always higher than that of the fluid in the third pipeline 103. Under the effect of the resulting pressure differential, the working fluid enters the power generation system, increasing the amount of working fluid available for work, enhancing working capacity, and increasing the output electrical power in response to the load increase operation.

The features of the working fluid filling control system described in the present application include the capability to achieve low-energy-consumption load variation control without the need for power sources such as fluid pumps. It utilizes the property of carbon dioxide working fluid, which exhibits a high density difference at different temperatures, to achieve automatic fluid replacement circulation. The system is equipped with both heating and cooling functions, enabling adjustable pressure and temperature of the working fluid inside the fluid tank to meet load variation requirements under different operating conditions. The cooling function also allows for a reduction in the configured volume of the working fluid tank. The system supports efficient and rapid load variation by adjusting the working fluid filling within the power generation loop, providing a more economical response to load changes compared to conventional throttling control and bypass regulation methods, as it avoids energy waste.

The system described in the present application is a closed-loop power generation cycle system with loop feedback characteristics. For instance, the turbine backpressure is correlated with the compressor inlet pressure, while the compressor outlet pressure is correlated with the turbine inlet pressure. A parameter change in one device, such as the compressor or the turbine, will affect the performance of the other. The system loop includes two compressors, i.e., the first and the second compressor 14, between which flow distribution occurs. These two compressors operate at different working points and exhibit different operating characteristics, necessitating consideration of compressor control and operational coordination. The inlet of the first compressor operates near the critical point, where fluid properties change drastically, exhibiting strong non-linear characteristics. The system operation is highly sensitive to such property variations, making system behavior analysis and control more complex. The system adopts both a high-temperature regenerator 6 and a low-temperature regenerator 7. The temperatures of the hot and cold fluid sides mutually affect one another. The outlet and inlet temperatures of the heat source are coupled, as are the compressor outlet and inlet temperatures, resulting in a system with strong coupling characteristics. It is therefore necessary to develop targeted control strategies and methods tailored to the load variation requirements, fluid properties, system configuration, and control characteristics. The advanced nuclear energy system proposed in the present application characterized by high efficiency, compactness, and inherent safety employs a local high-efficiency load variation control method. This includes working fluid filling control, bypass regulation, and throttling control, each capable of providing optimal load regulation strategies tailored to different load regions.

The nuclear power generation control method described in the present application features high efficiency, simplicity, rapid response, and energy conservation. Under high system load conditions (e.g., above 50% load level), it is suitable to select a highly efficient load variation method that minimizes energy waste and maintains thermal efficiency. In this scenario, the working fluid filling control and the throttling control are the most appropriate for achieving load regulation. The working fluid filling control functions by increasing or decreasing the working fluid mass within the cycle to adjust system load. The advantage of this method is that it enables power modulation while maintaining system efficiency. However, it requires working fluid storage tanks, which may become impractically large for high-power systems. Considering economic constraints, this method is better suited for small-range load variation. Therefore, the control method proposed in the present application divides the load variation range by a 20% load threshold. The throttling control operates by adjusting the main turbine control valve, that is, by regulating the valve opening on the turbine inlet pipeline 110, to modulate the rotational speed and working fluid flow rate, thereby achieving system load control. The advantages of this method include the absence of energy loss in the working fluid and the ability to maintain system efficiency with fast adjustment rates. Under low system load conditions (e.g., below 50% load level), efficiency is not the primary concern. In cases requiring frequent load variations, simpler and more direct methods become more suitable. Here, the working fluid filling control combined with the bypass regulation proves more effective. The bypass regulation achieves load modulation by diverting a portion of the working fluid, thereby adjusting the amount of fluid entering the turbine for power generation. This method's advantages lie in its simplicity and rapid response, making it suitable for frequent operations. However, its downside is energy waste, resulting in lower efficiency during load modulation, making it unsuitable for high-power or large-scale load variations from an energy conservation standpoint. Accordingly, the control method proposed in the present application also subdivides load variation strategies under low load conditions and uses a combination of the working fluid filling control and bypass regulation method for load modulation, based on their respective strengths. The detailed examples are as follows.

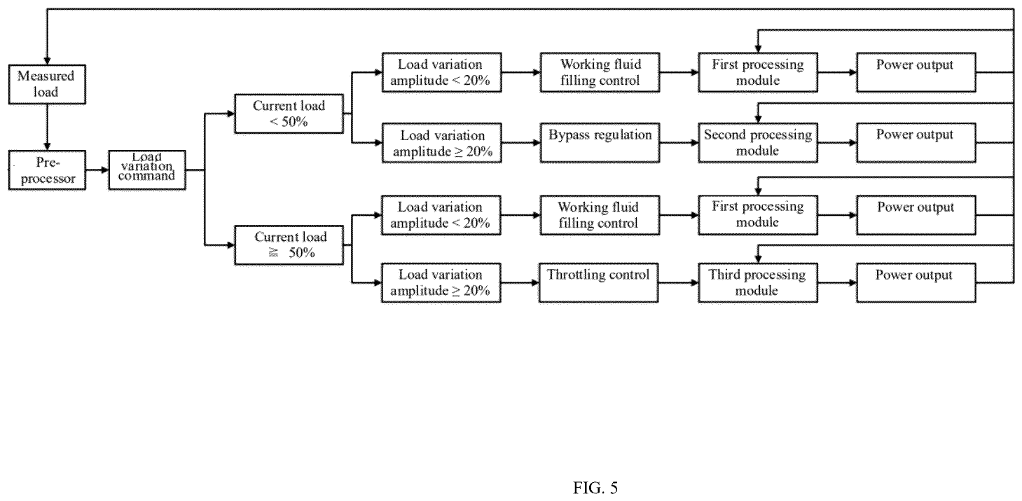

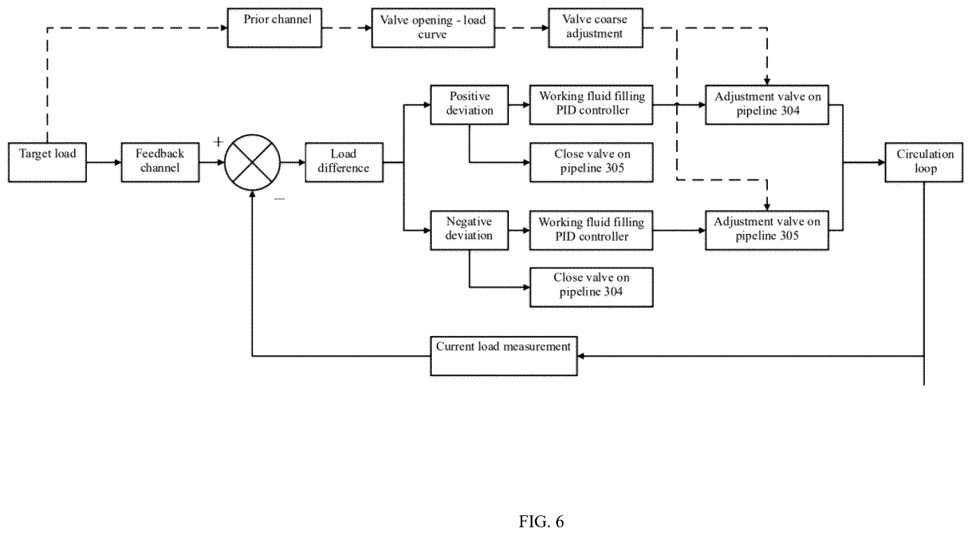

As shown in FIG. 5, the front-end processor monitors the external power grid load demand in real time, compares it with the actual measured load to generate a load variation command, and determines the load regulation to be executed based on the current load level and the magnitude of the load variation. If the load level is less than 50%, it further determines whether the load variation amplitude is less than 20%. If it is less than 20%, the working fluid filling control is adopted for load regulation. The process enters the first processing module, and the output power is adjusted through the first processing module. The current measured load is then fed back to the front-end processor, forming a closed-loop load control cycle. Conversely, if the load variation amplitude is greater than or equal to 20%, the bypass regulation is adopted. The process enters the second processing module, and the output power is adjusted accordingly. The current measured load is fed back to the front-end processor, forming another closed-loop load control cycle. If the load level is greater than or equal to 50%, the system again determines whether the load variation amplitude is less than 20%. If it is less than 20%, the working fluid filling control is applied. The process enters the first processing module, and the output power is adjusted via the first processing module. The current measured load is then fed back to the front-end processor, forming a closed-loop control cycle. Conversely, if the load variation amplitude is greater than or equal to 20%, the throttling control is adopted. The process enters the third processor, where the output power is adjusted, and the measured load is fed back to the front-end processor.

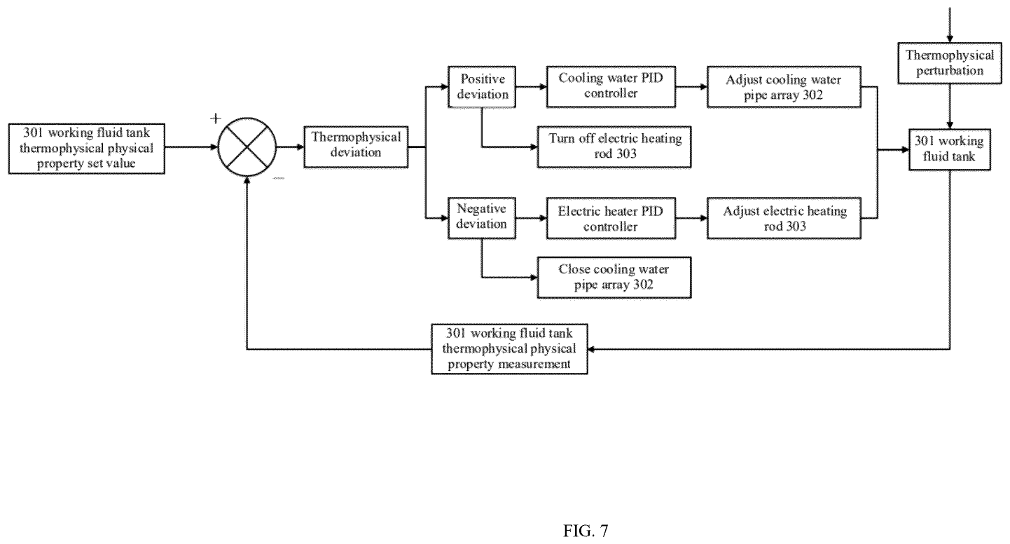

As shown in FIG. 6 and FIG. 7, the first processing module is divided into a load control section and a working fluid tank control section. FIG. 6 illustrates the load control section, while FIG. 7 illustrates the working fluid tank control section. The load control section adopts a feedforward-feedback closed-loop tracking control structure. Upon receiving the target load, one part enters the feedforward path and performs a coarse adjustment of the valve position based on the valve opening-load curve to enhance the system's rapid response to load changes. The other part enters the feedback path, where the load deviation is calculated by comparing the measured load with the target load. A PID valve controller is used to adjust the valve openings on the working fluid filling control system outlet pipeline 304 and inlet pipeline 305, thereby changing the amount of working fluid in the tank and ultimately adjusting the working fluid filling in the main power generation system to achieve precise output load control and ensure accurate tracking of load variations. The working fluid tank control section adopts a single closed-loop constant-value control structure. Its purpose is to maintain good regulation performance by adjusting the cooling water pipe array 302 and the electric heating rod 303 to counteract disturbances in the thermal properties of the working fluid in the tank 301 caused by changes in the valve openings of the tank's outlet and inlet pipelines.

The specific implementation includes, but is not limited to, the following: Upon receiving the target load, the first step is to perform a rough adjustment of the valve openings on the working fluid filling control system inlet pipeline 305 and outlet pipeline 304 based on the valve opening-load curve (which can be obtained through a finite number of experiments). Next, the target load is compared with the measured load to obtain the load deviation. When the deviation is positive, this indicates that the electrical power output of the generator 4 needs to be increased, and the turbine 3 needs to perform more work. At this point, the adjustment valve on the inlet pipeline 305 of the working fluid filling control system is closed, and the working fluid filling PID controller fine-tunes the valve on the outlet pipeline 304 to inject high-pressure, high-density working fluid into the main power generation system. This increases the working fluid filling in the system and raises the power output, effectively following the load demand.

Conversely, when the deviation is negative, the electrical power output of the generator 4 needs to be decreased, and the work output of the turbine needs to be reduced. In this case, the adjustment valve on the outlet pipeline 304 of the working fluid inventory control system is closed, and the working fluid inventory PID controller fine-tunes the valve on the inlet pipeline 305. High-pressure, high-density working fluid from the main power generation system enters the storage tank through the fourth pipeline 104 interface, thereby decreasing the working fluid inventory in the main power generation system and reducing the power output, again following the load demand.

Furthermore, during the valve adjustment process, changes in the working fluid inventory may lead to changes in the thermal properties of the working fluid tank, which may degrade the regulation performance. To maintain good regulation performance, the thermal properties of the working fluid tank 301 need to be kept close to the set value. When the working fluid is being charged into the tank, the temperature and pressure inside the tank rise. In this case, the electric heating rod 303 is turned off, and the cooling water PID controller adjusts the cooling water pipe array 302 to increase the cooling water flow, reducing the temperature and pressure inside the working fluid tank 301. This facilitates the injection of the main power generation system's working fluid into the working fluid tank.

When the working fluid is discharged from the tank, the temperature and pressure of the tank drop. In this case, the cooling water pipe array 302 is closed, and the PID controller for the electric heating rod 303 increases the heating power of the electric heating rod 303, raising the temperature and pressure inside the tank to facilitate the injection of working fluid from the tank into the main power generation system. It is noteworthy that the electric heating rod 303 and cooling water pipe array 302 continuously monitor the deviation between the thermal properties of the working fluid in the tank and the set values after each load change is performed. If a deviation is detected, heating and cooling methods can be used to restore the temperature and pressure inside the tank to the expected and set values, ensuring good regulation performance for the next load change operation.

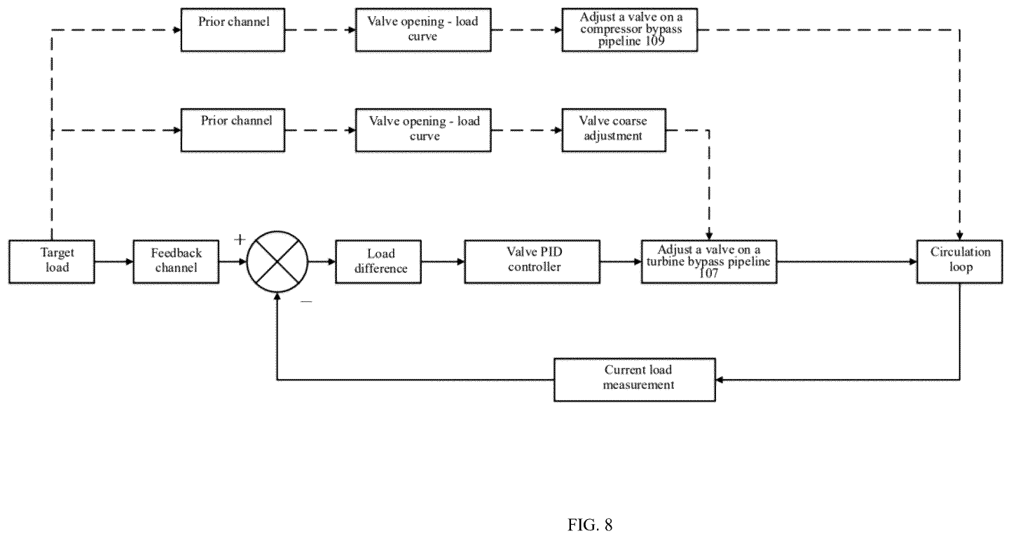

The second processing module, as shown in FIG. 8, adopts a dual-prior-single-feedback tracking control structure. Upon receiving the target load, one part enters the prior channel, where the valve openings on the turbine bypass pipeline 107 and compressor bypass pipeline 109 are roughly adjusted according to the valve opening-load curve to improve the system's rapid response to load changes. Another part enters the feedback channel, which only acts on the valve on the turbine bypass pipeline 107 to ensure control stability. The feedback channel compares the measured load with the target load to generate a load deviation. Using the valve position PID controller, the valve opening on the turbine bypass pipeline 107 is adjusted, thereby changing the working fluid flow in the main power generation system. This ultimately affects the work output of the turbine and the electrical power output of the generator, accurately responding to load change requirements.

The specific implementation method includes, but is not limited to the following. When the target load is received, the valve opening of the turbine bypass pipeline 107 and compressor bypass pipeline 109 is first obtained based on the valve opening-load curve (which can be obtained through a limited number of experiments), realizing a coarse adjustment of the valve positions. The next step is to compare the target load with the measured load to obtain the load deviation. If the calculated load deviation is negative, it means that the power output of the generator 4 needs to be increased, and the work output of the turbine 3 needs to be increased. In this case, the valve opening of the turbine bypass pipeline 107 is fine-tuned by the valve PID controller to reduce the flow of working fluid through the turbine bypass pipeline 107, thereby increasing the flow of working fluid through the main power generation system and increasing the power output, thus responding to the load demand. Conversely, if the deviation is positive, the flow of working fluid through the turbine bypass pipeline 107 is increased, reducing the flow of working fluid through the main power generation system and decreasing the power output, thus following the load demand. This regulation is known as the bypass regulation.

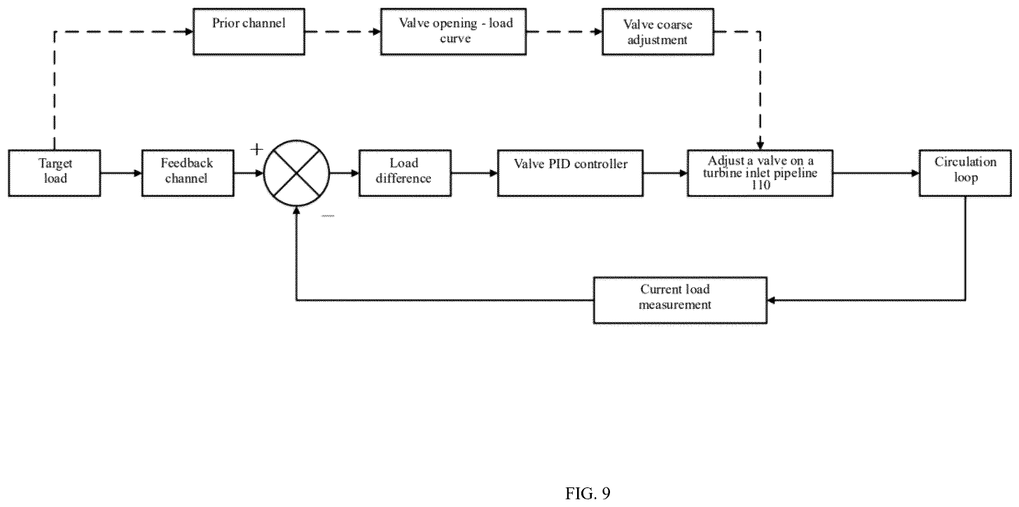

The third processing module, as shown in FIG. 9, adopts a prior-feedback tracking control structure. When the target load is received, part of the signal enters the prior channel, where the valve opening of the turbine inlet valve on the turbine inlet pipeline 110 is roughly adjusted according to the valve opening-load curve, to improve the quick response to load changes. The other part enters the feedback channel, where the load deviation is generated by comparing the target load with the measured load. The valve PID controller is used to adjust the valve opening of the turbine inlet valve on the turbine inlet pipeline 110, thereby changing the turbine inlet flow, which ultimately affects the turbine work output and generator power output, accurately responding to the load variation requirements.

The specific implementation includes but is not limited to the following. When the target load is received, the valve opening of the turbine inlet valve on the turbine inlet pipeline 110 is first roughly adjusted based on the valve opening-load curve (which can be obtained through a limited number of experiments). The next step is to compare the target load with the measured load to obtain the load deviation. If the calculated load deviation is negative, it means that the power output of the generator 4 needs to be increased, and the work output of the turbine 3 needs to be increased. At this point, the turbine inlet valve on the turbine inlet pipeline 110 is fine-tuned through the valve PID controller, increasing the turbine inlet flow, thereby increasing the turbine work output and generator power output to follow the load demand. Conversely, if the load deviation is positive, the turbine inlet flow is reduced, which in turn decreases the turbine work output and generator power output, following the load demand. This regulation is called the throttling control.

The working fluid filling control corresponds to the first processing module, the bypass regulation corresponds to the second processing module, and the throttling control corresponds to the third processing module. The above is only a specific embodiment of the present application and should not limit the scope of the application. Therefore, any equivalent substitution of components or equivalent changes and modifications made according to the scope of protection of the present application should still fall within the scope of the present application. Additionally, the technical features in the present application, as well as the technical features and technical solutions, technical solutions and technical solutions, and embodiments and embodiments, can be freely combined for use.

What is claimed is:

1. A nuclear power generation system with supercritical carbon dioxide as working fluid, comprising:
a main power generation system;
a waste heat discharging system;
a working fluid filling control system; and
a working fluid filling and recycling system,
wherein the main power generation system, the waste heat discharging system, the working fluid filling control system and the working fluid filling and recycling system each has the supercritical carbon dioxide as the working fluid;
the main power generation system is configured to convert thermal energy into electrical energy, and comprises a reactor and power generation system equipment;
the power generation system equipment comprises a turbine, a generator, a high-temperature recuperator, a low-temperature recuperator, a first cooler, a first pressurizing branch, and a second pressurizing branch, a first-stage compressor, a second cooler, and a second-stage compressor are sequentially arranged on the first pressurizing branch, a second compressor is arranged on the second pressurizing branch, the working fluid output from the reactor is configured to enter the turbine to perform work, the turbine is configured to drive the generator to generate electricity, and the spent working fluid after expansion is configured to sequentially enter the high-temperature recuperator and the low-temperature recuperator for heat release, the working fluid after heat release is configured to enter the first cooler for cooling, and the cooled working fluid is configured to enter the first-stage compressor for compression, the compressed working fluid is cooled in the second cooler, and the cooled working fluid is further compressed in the second-stage compressor, the high-pressure working fluid compressed by the first-stage compressor and the second-stage compressor is configured to sequentially enter the high-temperature recuperator and the low-temperature recuperator to absorb heat, the working fluid at the outlet of the low-temperature recuperator is further configured to enter the second compressor for compression, the high-pressure working fluid compressed by the second compressor is merged with the working fluid at the outlet of the low-temperature recuperator and re-enters the high-temperature recuperator to absorb heat, the heat-absorbed working fluid is further configured to enter the reactor to absorb heat and become a high-temperature and high-pressure working fluid;
the power generation system further comprises a first speed increaser, a first motor, a second speed increaser, a second motor, and a speed reducer; the first-stage compressor, the second-stage compressor, and the first motor are coaxially arranged; the first-stage compressor, the second-stage compressor, and the first motor are connected via gears within the first speed increaser; the second compressor and the second motor are coaxially arranged; the second compressor and the second motor are connected via gears within the second speed increaser; the turbine and the generator are coaxially arranged, and the turbine and the generator are connected via gears within the speed reducer;
the speed reducer, the first speed increaser, and the second speed increaser are each connected to a recovered working fluid inlet pipeline of the working fluid filling and recycling system through a first pipeline; and the inlet of the first cooler is in communication with a main power generation system working fluid filling outlet pipeline of the working fluid filling and recycling system via a second pipeline, the working fluid filling and recycling system is configured to recycle the working fluid; and
the working fluid filling and recycling system comprises the recovered working fluid inlet pipeline, a filling heat exchanger, a working fluid storage tank, and a second heater, an outlet of the recovered working fluid inlet pipeline is connected to a heat release inlet of the filling heat exchanger; a heat release outlet of the filling heat exchanger is connected to an inlet of the working fluid storage tank through a heat release branch pipeline; a heat absorption inlet of the filling heat exchanger is connected to an outlet of the working fluid storage tank through a heat absorption inlet branch pipeline; a heat absorption outlet of the filling heat exchanger is connected to an inlet of the second heater through a heat absorption outlet branch pipeline; an outlet of the second heater is in communication with an inlet of the first cooler through a main power generation system working fluid filling outlet pipeline; the outlet of the second heater is further connected in sequence to the active waste heat discharging system pipeline through an active waste heat discharging system filling outlet pipeline and a fifth pipeline; and the outlet of the second heater is also connected in sequence to the passive waste heat discharging system pipeline through a passive waste heat discharging system filling outlet pipeline and a sixth pipeline.

2. The nuclear power generation system according to claim 1, wherein a reactor working fluid outlet is connected to an inlet of the turbine via a turbine inlet pipeline, an outlet of the turbine is connected to a heat release inlet of the high-temperature recuperator via an exhaust gas delivery pipeline, a reactor working fluid inlet is connected to a heat absorption outlet of the high-temperature recuperator via a working fluid input pipeline, and a compression outlet of the second stage of the first compressor is connected to a heat absorption inlet of the low-temperature recuperator through a high-pressure working fluid delivery pipeline.

3. The nuclear power generation system according to claim 2, wherein the turbine inlet pipeline is connected to the exhaust gas delivery pipeline through a turbine bypass pipeline, and the turbine bypass pipeline is configured to implement load regulation and load shedding;
the working fluid input pipeline is connected to the turbine inlet pipeline through a reactor bypass pipeline, and the reactor bypass pipeline is configured to isolate the reactor from the main power generation system; and
the high-pressure working fluid conveying pipeline is in communication with an inlet of the first cooler through a first compressor bypass pipeline, and the first compressor bypass pipeline is configured to implement working fluid flow regulation and load regulation.

4. The nuclear power generation system according to claim 1, wherein the first cooler, the second cooler, the high-temperature recuperator, and the low-temperature recuperator are all configured as PCHE-type microchannel high-efficiency heat exchangers.

5. The nuclear power generation system according to claim 1, wherein an inlet of the first cooler is in communication with a working fluid filling control system outlet pipeline of the working fluid filling control system through a third pipeline, and an outlet of the second compressor is in communication with a working fluid filling control system inlet pipeline of the working fluid filling control system through a fourth pipeline, the working fluid amount control system is configured to vary a load of the main power generation system.

6. The nuclear power generation system according to claim 2, wherein the reactor comprises a control rod drive mechanism, a reactor vessel, a reactor core, a coolant, a coolant pump, and an intermediate heat exchanger, the control rod drive mechanism is configured to move the reactor core up and down;
the reactor core, the coolant, the coolant pump, and the intermediate heat exchanger are all disposed within the reactor vessel;
the reactor core is configured to release heat to the coolant;
the coolant pump is configured to circulate the coolant;
the coolant is configured to release heat to the intermediate heat exchanger;
the working fluid in the main power generation system is configured to enter the intermediate heat exchanger to absorb heat;
an inlet of the intermediate heat exchanger is in communication with the reactor working fluid inlet; and
an outlet of the intermediate heat exchanger is in communication with the reactor working fluid outlet.

7. The nuclear power generation system according to claim 6, wherein the intermediate heat exchanger is a printed circuit heat exchanger, a plurality of intermediate heat exchangers are arranged circumferentially along the reactor vessel, and each intermediate heat exchanger has a high-temperature side and a low-temperature side; and
the coolant is a liquid metal coolant and flows through the high-temperature side, and the working fluid of the main power generation system flows through the low-temperature side.

8. The nuclear power generation system according to claim 6, wherein the reactor further comprises a thermally conductive internal partition, and the reactor vessel is divided by the thermally conductive internal partition into a working chamber and an auxiliary chamber that are independent of each other;
the reactor core, the coolant, the coolant pump, and the intermediate heat exchanger are all located within the working chamber of the reactor vessel;
an upper portion of the auxiliary chamber is annular in shape, and a lower portion of the working chamber is inserted within the upper portion of the auxiliary chamber; and
a waste heat outlet and a waste heat inlet are provided on the reactor vessel, and both the waste heat outlet and the waste heat inlet are in communication with the auxiliary chamber.

9. The nuclear power generation system according to claim 8, wherein the waste heat discharging system comprises an active waste heat discharging system pipeline, and the supercritical carbon dioxide serves as a circulating cooling working fluid within the active waste heat discharging system pipeline;
along a direction from an inlet to an outlet of the active waste heat discharging system pipeline, a fourth cooler, a first booster pump, and a first heater are sequentially arranged on the active waste heat discharging system pipeline; and
the inlet of the active waste heat discharging system pipeline is in communication with the reactor working fluid outlet, and the outlet of the active waste heat discharging system pipeline is in communication with the reactor working fluid inlet.

10. The nuclear power generation system according to claim 9, wherein
when the reactor is shut down under normal conditions and the active waste heat discharging system pipeline is activated to perform cooling, a first valve on the working fluid input pipeline is closed, and a second valve on a reactor bypass pipeline is opened, so that the high-pressure working fluid having absorbed heat from the high-temperature recuperator does not enter the reactor but instead enters the turbine through the reactor bypass pipeline, and the working fluid discharged from the reactor working fluid outlet is returned to the reactor working fluid inlet through the fourth cooler and the first booster pump in the active waste heat discharging system pipeline, thereby cooling the reactor core; and
when the reactor is shut down for maintenance and heating is required to maintain the temperature of the coolant, the working fluid discharged from the reactor working fluid outlet is returned to the reactor working fluid inlet through the first booster pump and the first heater in the active waste heat discharging system pipeline, thereby providing heat tracing for the coolant of the reactor core.

11. The nuclear power generation system according to claim 8, wherein the waste heat discharging system comprises a passive waste heat discharging system pipeline, the passive waste heat discharging system pipeline employs the supercritical carbon dioxide as a circulating cooling working fluid, and a third cooler is disposed on the passive waste heat discharging system pipeline;
the third cooler is located inside a water tank, and the third cooler is provided with a cold source by the water tank; and
an inlet of the passive waste heat discharging system pipeline is in communication with both the reactor working fluid outlet and the waste heat outlet, and an outlet of the passive waste heat discharging system pipeline is in communication with both the reactor working fluid inlet and the waste heat inlet.

12. The nuclear power generation system according to claim 11, wherein
when an emergency shutdown of the reactor occurs and the passive waste heat discharging system pipeline is activated to perform cooling, the circulating cooling working fluid in the passive waste heat discharging system pipeline enters the reactor from the reactor working fluid outlet and the waste heat outlet, and the circulating cooling working fluid within the reactor enters the passive waste heat discharging system pipeline from the reactor working fluid inlet and the waste heat inlet.

13. The nuclear power generation system according to claim 1, wherein the recovered working fluid inlet pipeline is sequentially provided with an induced draft fan, an oil-gas separation and cooling device, a high-temperature heating furnace, a dust filter, and a dryer in a direction from an inlet to the outlet of the recovered working fluid inlet pipeline;
an inlet of the high-temperature heating furnace is in communication with an exhaust port of the oil-gas separation and cooling device;
an oil discharge port of the oil-gas separation and cooling device is sequentially connected to an oil filter, a sixth cooler, and a lubricating oil tank;
a fifth cooler is disposed on the heat release branch pipeline; and
a second booster pump is disposed on the heat absorption inlet branch pipeline.

14. The nuclear power generation system according to claim 5, wherein the working fluid filling control system comprises a working fluid tank, an outlet of the working fluid tank is connected to a working fluid filling control system outlet pipeline, and an inlet of the working fluid tank is connected to the working fluid filling control system inlet pipeline; and
the working fluid tank is connected to a cooling water pipe array and an electric heating rod, the cooling water pipe array is configured to cool the working fluid inside the working fluid tank, and the electric heating rod is configured to heat the working fluid inside the working fluid tank.
